(19) United States
(12) Patent Application Publication
(10) Pub. No.: US 2025/0230031 A1
(43) Pub. Date: Jul. 17, 2025

(54) PORTABLE BULK FUEL STORAGE AND DISCHARGE APPARATUS

(71) Applicant: SCEPTER US HOLDING COMPANY, Akron, OH (US)

(72) Inventors: Kristopher SNYDER, Claremore, OK (US); Arash NIKSERESHT, Aurora (CA); Geoffrey Allen KING, London, OH (US)

(21) Appl. No.: 19/015,163

(22) Filed: Jan. 9, 2025

Related U.S. Application Data
(60) Provisional application No. 63/619,992, filed on Jan. 11, 2024.

(51) Int. Cl. B67D 7/04; B67D 7/00; B67D 7/42; B67D 7/84

(52) U.S. Cl. CPC B67D 7/04; B67D 7/005; B67D 7/42; B67D 7/84; B67D 2210/00133

(57) ABSTRACT

A fuel tank assembly comprise may comprise a tank, a pump, a hose, and a hose hanger. The tank defines an interior volume for holding fluid. The pump is in communication with the interior volume of the tank and includes an output nozzle. The hose is coupled to the output nozzle and is operable to receive fluid transmitted by the pump. The hose hanger is operatively coupled to the tank and configured to retain the hose. The fuel tank assembly may also include a dispensing apparatus on a distal end of the hose for discharging fluid received from the pump.

### CROSS-REFERENCE TO RELATED APPLICATIONS

This application claims benefit of and priority to U.S. Provisional Patent Application No. 63/619,992 filed 11 Jan. 2024, the disclosure of which is hereby incorporated by reference in its entirety.

### FIELD

The present disclosure relates to an apparatus for the storage, transport, and disposal of fuel. More particularly, the disclosure relates to a portable apparatus operable to contain and discharge bulk volumes of fuel.

### BACKGROUND

Portable containers capable of storing and discharging bulk volumes of fuel are often needed in commercial and industrial settings as well as in recreational settings when it is not possible to transport the vehicle in need of fuel to a fuel tank or station. In such settings, it is advantageous to utilize a fuel container capable of high-capacity volumes of fuel that can be easily transported and easily dispensed. Accordingly, a need exists for an improved device capable of storing, transporting, and discharging bulk volumes of fuel.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

Embodiments of a fuel tank assembly are disclosed herein. The fuel tank assembly may include a tank defining an interior volume, and a pump in communication with the interior volume of the tank. The pump includes an output nozzle, and the fuel tank assembly further includes a hose coupled to the output nozzle of the pump, such that the hose is operable to receive fluid transmitted by the pump. The fuel tank assembly also includes a hose hanger operatively coupled to the tank and configured to retain the hose.

In other embodiments consistent with the present disclosure, a fuel tank assembly includes a tank defining an interior volume, a pump in communication with the interior volume of the tank, the pump includes an output nozzle, a hose coupled to the output nozzle of the pump, such that the hose is operable to receive fluid transmitted by the pump, a hose hanger operatively coupled to the tank and configured to retain the hose, a power source operative to power the pump, a dispensing apparatus provided on a distal end of the hose, the dispensing apparatus being operable to discharge fluid received from the pump though the hose, and a rolling apparatus operatively coupled to the tank and configured to enable the transport of the assembly.

In other embodiments consistent with the present disclosure, a fuel tank assembly includes a tank defining an interior volume, a pump in communication with the interior volume of the tank, the pump includes an output nozzle, a hose coupled to the output nozzle of the pump, such that the hose is operable to receive fluid transmitted by the pump, and a hose hanger operatively coupled to the tank and configured to retain the hose. The hose hanger further includes a power jack that is in electrical communication with the pump, the power jack configured to receive power from an external power source, and a tray configured to retain a plurality of batteries, the tray being removably provided within a cavity of the enclosure portion. The fuel tank assembly further includes a wire harness electrically connecting the pump to both the tray and the power jack, a dispensing apparatus provided on a distal end of the hose, the dispensing apparatus being operable to discharge fluid received from the pump though the hose, and a rolling apparatus operatively coupled to the tank and configured to enable the transport of the assembly.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1A illustrates an example fuel tank assembly that may incorporate the principles of the present disclosure.

FIG. 1B is a rear view of the fuel tank assembly of FIG. 1A.

FIG. 1C is an exploded, schematic side view of the fuel tank assembly of FIGS. 1A and 1B.

FIG. 2A is schematic front perspective view of a tank of the fuel tank assembly of FIG. 1A, according to one or more embodiments of the present disclosure.

FIG. 2B is a front view of the tank of FIG. 2A.

FIG. 2C is a close up view of the rolling apparatus of FIG. 1A attached to the tank of FIG. 1.

FIG. 3A is a perspective view of the hose hanger of FIG. 1 assembled in the fuel tank assembly of FIG. 1A, according to one or more embodiments of the present disclosure.

FIG. 3B is a top view of the hose hanger of FIG. 3A.

FIG. 3C is a side view of the hose hanger when removed from the tank.

FIG. 3D is a perspective view of the hose hanger when removed from the tank.

FIG. 4A is a partial schematic view of the fuel tank assembly, wherein the pump is installed on the tank and connected to the hose hanger and the fuel pickup assembly.

FIG. 4B is an enlarged view of a portion of the assembly where the pump is disconnected from the hose hanger and the fuel pickup assembly.

FIG. 4C depicts a fuel pickup assembly, according to one or more embodiments of the present disclosure.

FIG. 5A is a perspective view of the fuel cap utilizable in the fuel tank assembly of FIG. 1, according to one or more embodiments of the present disclosure.

FIG. 5B is a front view of the fuel cap of FIG. 5A.

FIG. 5C is a side cross-sectional view of the fuel cap of FIG. 5B.

FIG. 5D is a view of a detail B in FIG. 5C.

FIG. 6A depicts the hose assembly of the fuel tank assembly of FIG. 1.

FIG. 6B depicts the hose clip of FIG. 6A, according to one or more embodiments.

FIG. 7 depicts the dispensing apparatus of the fuel tank assembly of FIG. 1A.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to apparatuses for the storage, transport, and disposal of fuel. More particularly, the disclosure relates to a portable apparatus operable to contain and discharge large volumes of fuel.

Embodiments of the present disclosure are advantageous over because the gas storage apparatus disclosed herein is capable of easy transport and a compact, powered dispensing option. In circumstances where large volume of gas must be transported (e.g., boat or ATV requiring more than ten gallons of gas) it is advantageous to utilize a container that is mobile and can be dispensed without much effort on the part of the user/operator.

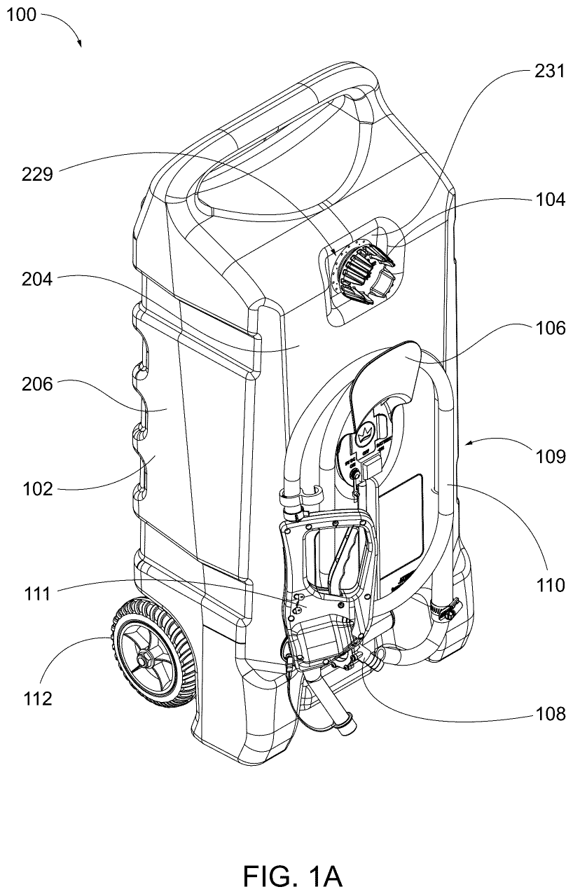

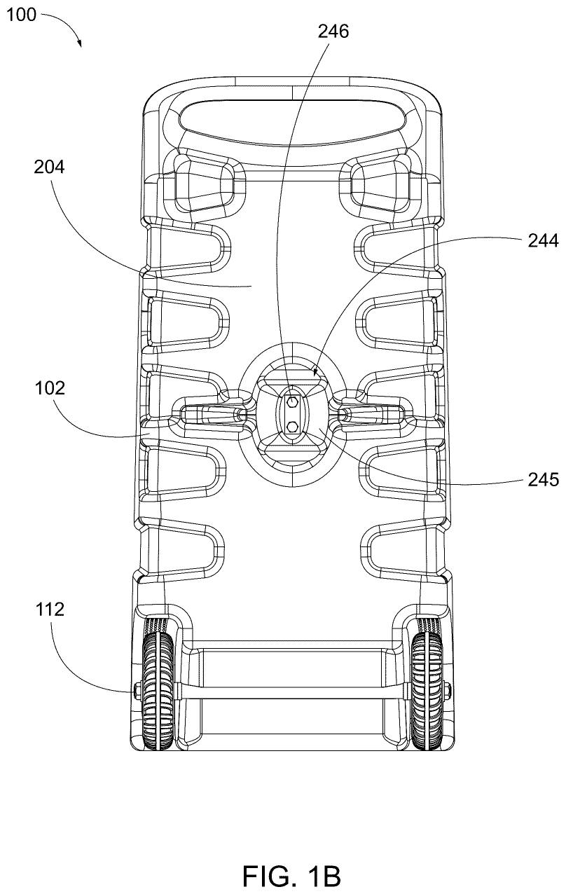

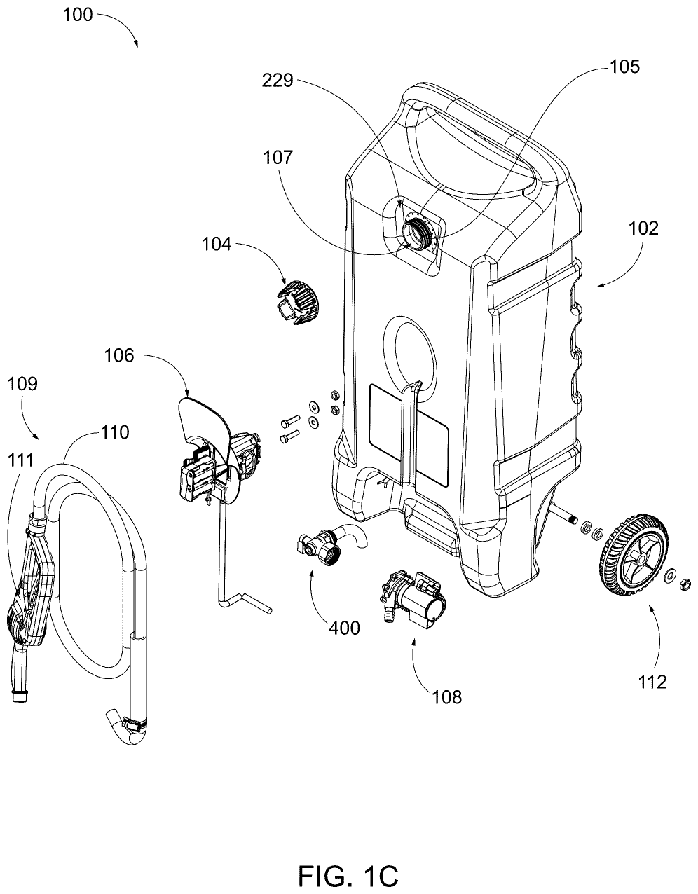

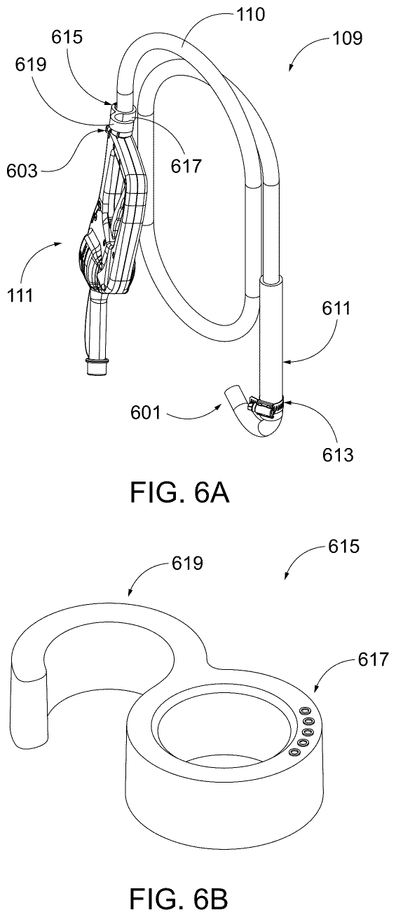

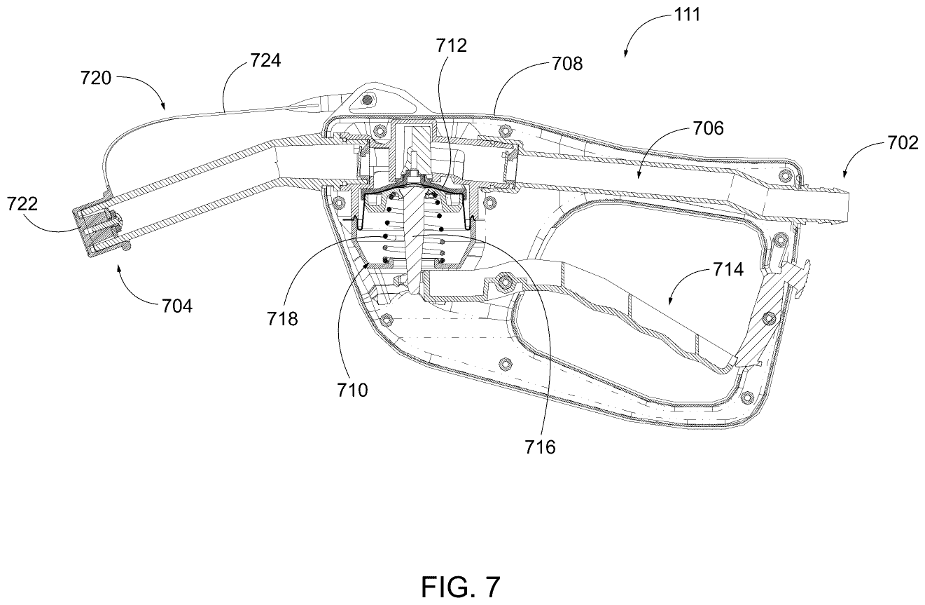

FIG. 1A illustrates an example fuel tank assembly 100 (hereinafter, “the assembly 100”) that may embody or otherwise employ one or more principles of the present disclosure. FIG. 1B is a rear view of the assembly 100, and FIG. 1C is an exploded schematic side view of the assembly 100. While FIGS. 1A and 1B illustrate the assembly 100 when fully assembled, in FIG. 1C, the assembly 100 is depicted in an un-assembled state so that the various components of the assembly 100 may be more easily identifiable. As shown, the assembly 100 includes a tank 102, a fuel cap 104, a hose hanger 106, a pump 108, a fuel pickup assembly 400, a hose assembly 109, and a rolling apparatus 112. The hose assembly 109 includes a hose 110 and a dispensing apparatus 111 connected at an end of the hose 110, and is further discussed below, with reference to FIGS. 6A-6B and FIG. 7.

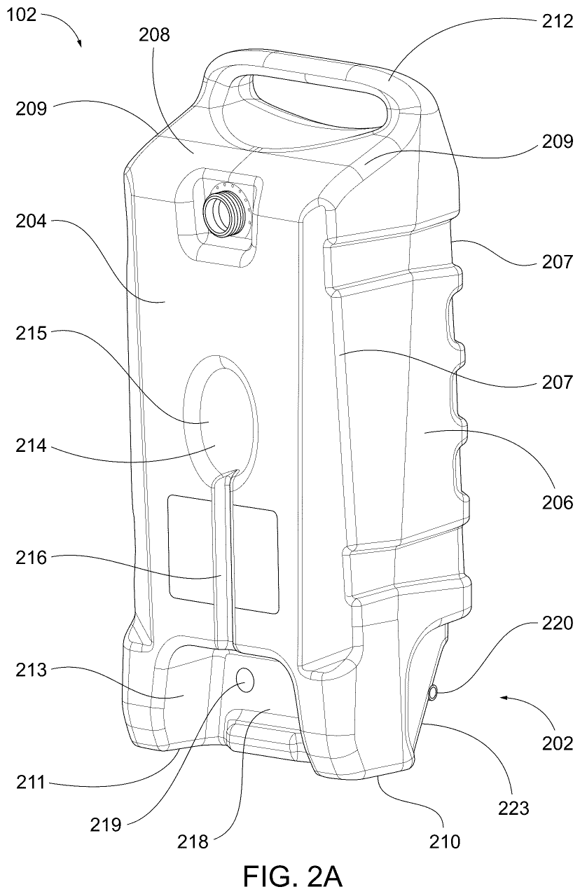

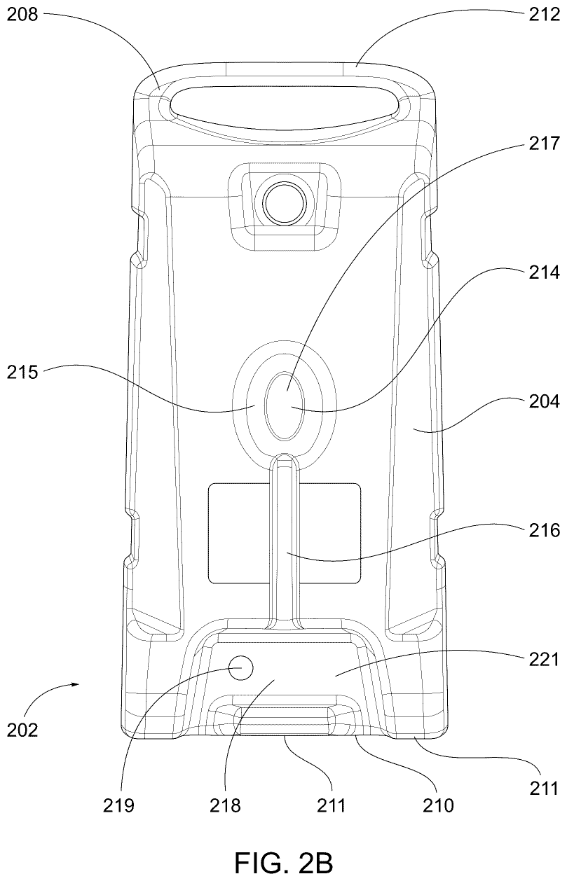

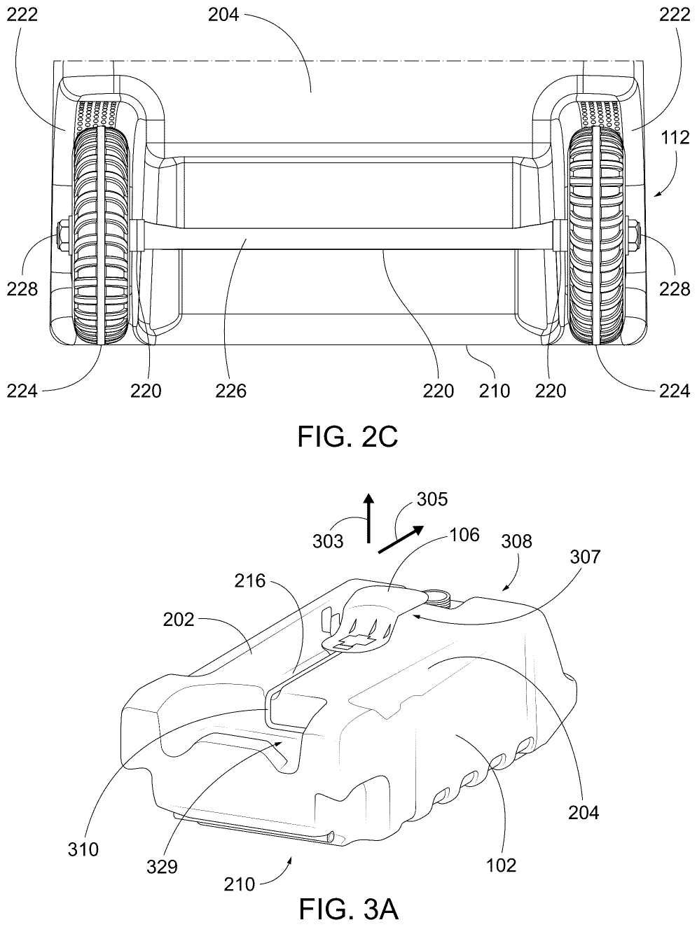

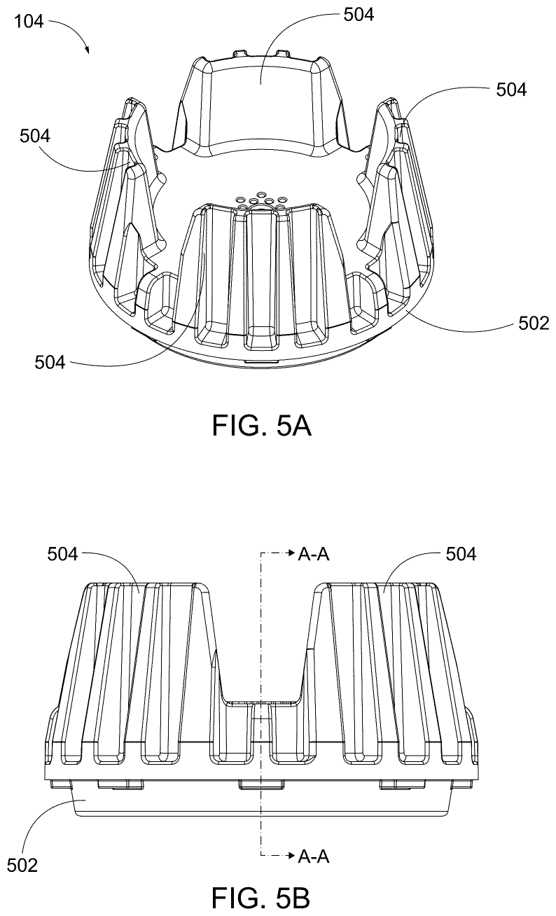

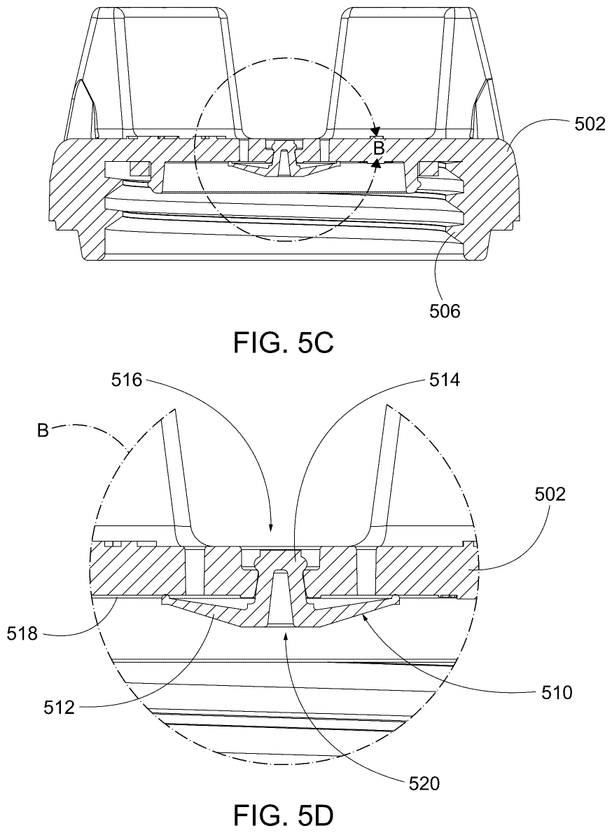

The tank 102 comprises a container operable to receive and retain a volume of fuel. Accordingly, the tank 102 may be constructed a material functional to withstand the properties of fuel, or more particularly, gasoline. In the present embodiment, the tank 102 comprises polyethylene. Accordingly, the tank 102 may comprise any known material capable of contact with fuel, without departing from the scope of this disclosure. The tank 102 includes a neck 105 that extends from the tank 102, and the neck 105 includes an opening that is in communication with an interior volume/space of the tank 102 such that the fuel may be introduced to and from the interior of the tank via the opening 107 in the neck 105. The fuel cap 104 may be provided on the neck 105 of the tank 102 to close the opening 107. In embodiments, the fuel cap 104 is removable from the neck 105 of the tank 102, for example, the fuel cap 104 may include threads that mate with threads on the neck 105 of the tank 102. In embodiments, the fuel cap 104 is operable to vent (or provide venting) to the interior volume of the tank 102. The tank 102 is discussed in further detail with reference to FIGS. 2A-2C, and the fuel cap 104 is further discussed below with reference to FIGS. 5A-5D.

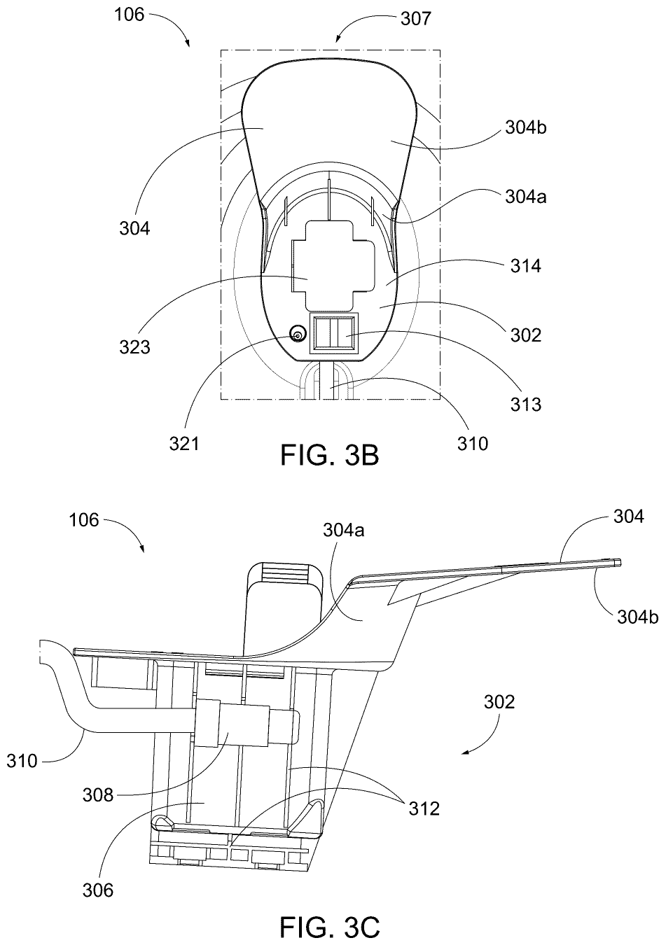

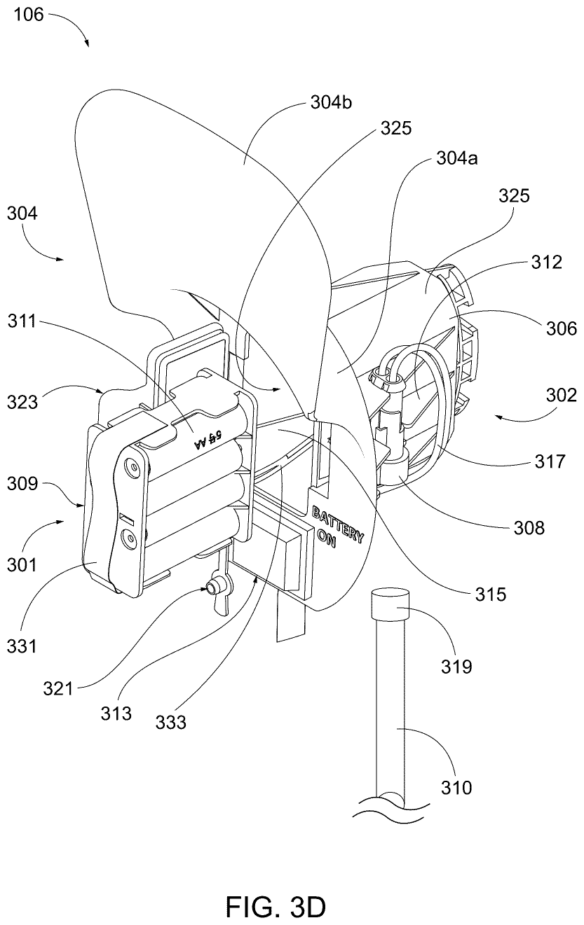

The hose hanger 106 is at least partially recessed within the tank 102 and comprises an apparatus operable to retain the hose 110. For example, the hose 110 comprises an extended hose body that may be at least partially wrapped around or draped over the hose hanger 106. The hose hanger 106 also operable to receive a power source that powers the pump 108, and the hose hanger 106 may also include features operable for transmitting power from the power source to the pump 108. The hose hanger 106 is discussed in further detail with reference to FIGS. 3A-3D.

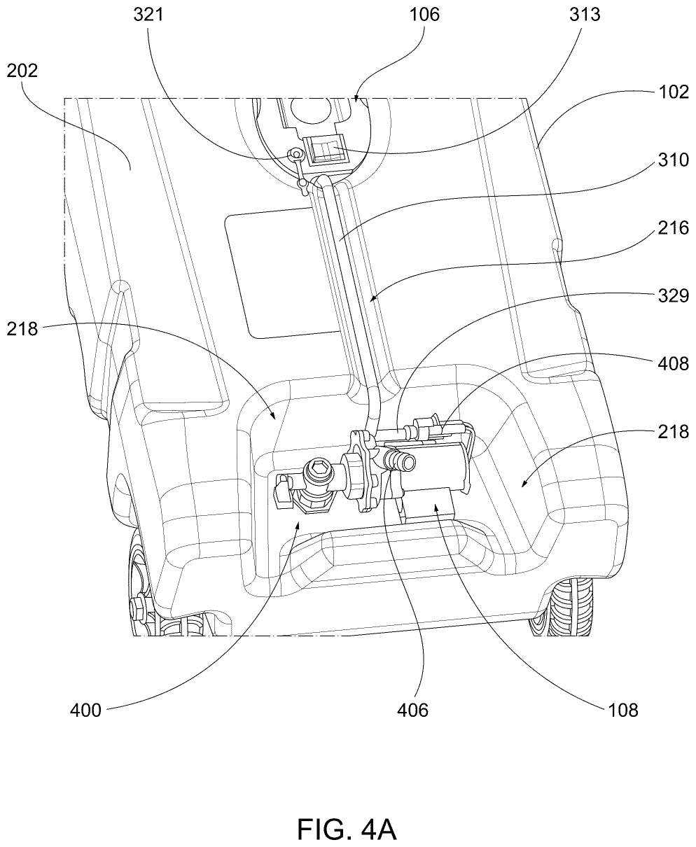

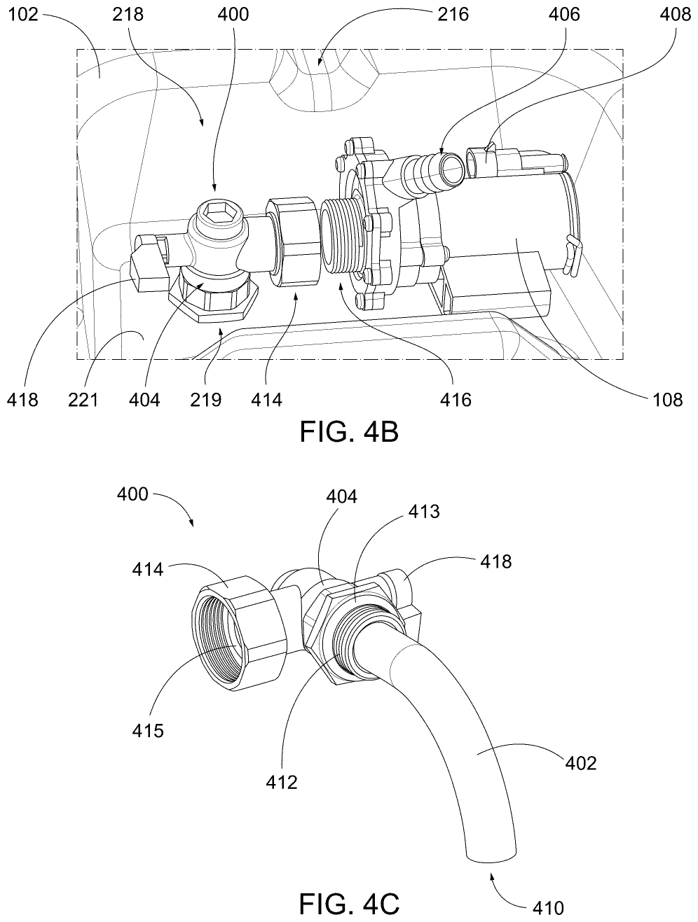

The fuel pickup assembly 400 is in communication with the interior volume of the tank 102 and an input of the pump 108. The pump 108 is in communication with an output of fuel pickup assembly 400 and the hose 110, and comprises an apparatus operable to draw fluid (fuel) from the interior volume of the tank 102 via the fuel pickup assembly 400 and then direct/send/discharge/transmit that fluid (fuel) into the hose 110. As mentioned above, in the present embodiment, the pump 108 is electrically connected to the power source such that the pump 108 draws power from and is powered by the power source. The pump 108 is discussed in further detail with reference to FIGS. 4A-4B. The fuel pickup assembly 400 is discussed in further detail with reference to FIG. 4C.

The hose 110 comprises a generally cylindrical exterior body with a hollow interior. The hollow interior of the hose 110 is operable to receive and transmit fluid (fuel), from the interior volume of the tank 102, to the dispensing apparatus 111 and ultimately into a user selected apparatus into which the dispensing apparatus 111 may deliver the fluid (fuel), such as a tractor, ATV, vehicle etc. Accordingly, the hose 110 may comprise a generally flexible material in order to provide the user accessibility in utilizing the assembly 100. The hose 110 may further be operable to be retained by the hose hanger 106. In FIG. 1A, the hose is shown partially wrapped around the hose hanger 106. The hose 110 further includes a distal end and FIG. 1A illustrates the dispensing apparatus 111 being connected to the distal end of the hose 110. In other embodiments, the distal end of the hose 110 may be connected to a different type of nozzle or other means of enabling the transfer of fluid (fuel) from the hose 110 into a vehicle, instead of the dispensing apparatus 111. The hose 110 also includes a proximal end that is connected to the pump 108.

The rolling apparatus 112 may comprise one or more wheels operatively coupled to the exterior of the tank 102. As described below, the rolling apparatus 112 functions to provide the assembly 100 with mobility and portability and thereby ease of use to the user. The rolling apparatus 112 to be discussed in further detail with reference to FIG. 2C.

FIGS. 2A-2B depict isometric front and front views of the tank 102, according to one or more principles of the present disclosure. The tank 102 comprises a substantially body 202. In the illustrated embodiment, the body 202 is substantially rectangular shaped, but may be other shapes in other embodiments. The body 202 may be defined by a first pair of opposing sidewalls 204 of relatively longer walls and a second pair of opposing sidewalls 206 of relatively shorter walls. The first pair of opposing sidewalls 204, which include a front sidewall 204 (shown in FIG. 1A) and a rear sidewall 204 (shown in FIG. 1B), are operatively coupled to the second pair of opposing sidewalls 206 via corner portions 207. The tank 102 further includes a top wall 208 operatively coupled to upper edges 209 of the sidewalls 204, 206 and a base (or bottom wall) 210 operatively coupled to lower edges 211 (opposite the top wall 208) of the sidewalls 204, 206, thereby making the body 202 operable to receive and contain a volume of fluid. In the present embodiment, the tank is operable to contain a volume of 14 gallons (˜53 liters). In other embodiments, the tank may be operable to contain a volume of more or less than 14 gallons.

The top wall 208 of the tank 102 includes a handle 212 operable for a user to hold and maneuver the assembly 100. The handle 212 may be operatively coupled to the body 202 via weld or by other known means. The body 202 further includes a cavity 214 defined within the exterior body of the (front) sidewall 204 (hereinafter referred to as the “front”). In the illustrated embodiment, the cavity 214 is generally circular in shape and is defined a beveled (chamfered) sidewall 215 angling inward, from the front sidewall 204 towards a base surface 217 of the cavity 214 such that the sidewall 215 terminates at the base surface 217. As detailed herein, the cavity 214 is operable to receive the hose hanger 106. Thus, the cavity 214 may have various other shapes depending on the shape of the hose hanger 106 which it is to receive.

The front sidewall 204 of the tank 102 may further include a channel 216 defined within the front sidewall 204 of the body 202. The channel 216 may extend from the cavity 214 toward the base 210 of the tank 102. The channel 216 may be of a depth configured to receive and secure a wire harness or extension of wire enabling the operability of the pump 108. In embodiments, the channel 216 has a similar depth as the base surface 217 of the cavity 214, whereas, in other embodiments, it may have a lesser depth (i.e., be shallower) than the base surface 217.

The front sidewall 204 of the tank 102 may further include a pocket 218 defined within the exterior body 202. The pocket 218 may be configured and operable to receive and secure the pump 108. Thus, the pocket 218 may have a geometry and may be sized corresponding to the size and geometry of the pump 218. The pocket 218 may be positioned proximate to the base 210 of the tank 102, such that the pocket 218 borders the base 210 and such that the pocket 218 terminates into the front lower edge 211 at the junction between the front sidewall 204 and the base 210. Similar to the cavity 214, the pocket 218 may be defined by chamfered sidewalls 213 angling inwardly from the front sidewall 204 toward the interior body of the pocket 218. In the present embodiment, the sidewalls 213 of the pocket 218 angle inwardly at approximately 10 degrees such that the pocket 218 is positioned approximately 0.5 inches below the surface of the front sidewall 204. In the present embodiment, the width of the pocket 218 is approximately 7.75 inches, wherein the depth of the pocket 218 is approximately 3.50 inches. In other embodiments, the pocket 218 may comprise varying other dimensions without departing from the scope of this disclosure. In embodiments, a base surface 221 of the pocket 218 may have the same depth as the base surface 217 of the cavity 214, whereas, in other embodiments, the base surface 221 of the pocket 218 may be more shallow than or deeper than the base surface 217.

The pocket 218 may further include an aperture 219. The aperture 219 may be defined within the exterior base surface 221 of the pocket 218. The aperture 219 is an opening that is in communication with the interior volume of the tank 102 and is configured to receive a portion or component of the pump 108, such that the pump 108 may draw fluid (fuel) from the interior volume of the tank 102 via the aperture 219. For example, as discussed below, the aperture 219 may receive a fitting operatively coupled to a valve of the pump 108 (i.e., a valve fitting). In embodiments, a corresponding fitting may be provided within the aperture 219 (e.g., a brass fitting), wherein such corresponding fitting includes interior threads that may be configured to threadingly engage threads that may be defined upon the exterior of the valve fitting of the pump 108. As illustrated, the channel 216 may terminate into the pocket 218, such that the channel 216 extends between the cavity 214 and the pocket 218 thereby defining a conduit on the front sidewall 204 within which wires or cables may be routed such that, as detailed below, electrical power may be supplied to the pump 108 from the power source contained in the hose hanger 106.

Referring again to FIGS. 1A and 1C, the front sidewall 204 of the tank 102 may further include a nozzle pocket 229 defined within the exterior body 202 within which the neck 105 of the tank 102 is arranged. The nozzle pocket 229 is a recessed space with a surface 231 that is offset inwardly from the front sidewall 204, and the neck 105 extends outwardly from the surface 231. The nozzle pocket 229 provides a space within which the fuel cap 104 may be disposed when screwed onto the neck 105, such that the fuel cap 104 is less exposed than if the neck were to extend from another sidewall of the tank 102 (e.g., such as the front sidewall 204), and such that the fuel cap 104 does not prominently protrude from the tank 102 in a manner where it could be caught on objects when the assembly 100 is being moved or transported. Also, by recessing the neck 105 within the nozzle pocket 229, the nozzle and the fuel cap 104 will be protected such that they are less susceptible to breakage/fracture resulting from being impacted if the assembly 100 were to tip over or fall.

Referring now to FIG. 1B, the back sidewall 204 may be configured to facilitate attachment of the hose hanger 106 within the cavity 214 of the front sidewall 204. In the illustrated embodiment, the back sidewall 204 includes a rear hanger cavity 244. The rear hanger cavity 244 extends into the back sidewall 204 and includes a base surface 245 that is offset inwardly of the back sidewall 204, such that the base surface 245 of the rear hanger cavity 244 and the base surface 217 of the cavity 214 are closer together than the rear sidewall 204 and the front sidewall 204. The rear hanger cavity 244 is positioned on the back sidewall 204 at a location thereon corresponding with the cavity 214 on the front sidewall 204, such that the cavities 214, 244 are equidistantly positioned relative to the sidewalls 206 and equidistantly positioned relative to the bottom wall 210 and top wall 208. With this construction, an interior surface of the base surface 245 of the cavity 244 will face and be substantially aligned with an interior surface of base surface 217 of the cavity 214. One or more channels 246 may formed through the tank 102, with the one or more channels 246 extending through the base surface 245 of the cavity 244 and the base surface 217 of the cavity 214, such that a fastener (e.g., a screw) may be inserted there through without comprising the tanks 102 ability to retain fluid without leaking.

Still referring to the tank 102, the back sidewall 204 (opposite the front sidewall 204) is configured to accommodate the rolling apparatus 112, and the rolling apparatus includes a pair of wheels 224 mounted on an axel 226. In the illustrated embodiment, portions of the back sidewall 204 may be configured to accommodate portions of the rolling apparatus 112 (i.e., to accommodate the wheels 224). In the illustrated embodiment, the back sidewall 204 includes a portion 223 that is angled inwardly and terminating into the base 210. In the illustrated embodiment, the back sidewall 204 may further include an indentation 220 defined within the exterior of the angled portion of the back sidewall 204. The indentation 220 may be configured to receive and secure the axle 226 of the rolling apparatus 112. In addition, a receptacle 222 may be formed in each of the left and right sidewalls 206 of the tank 102, at a location proximate to the base 210 and the inclined portion 223 of the back sidewall 204, each of the receptacles 222 for receiving one of the wheels 224. When the axle 226 is disposed in the indentation 220 and the wheels 224 are connected to the axel 226, the inclined/angled orientation of the portion 223 allows a portion of the wheels 224 to extend beyond and be exposed outward of the tank 102, such that the exposed portions of the wheels 224 may contact the ground surface, which in turn allows the apparatus 100 to be rolled/moved on the wheels 224 when tilted rearward (i.e., when tilted in a direction from the front sidewall 204 towards the rear sidewall 204).

Referring now to the rolling apparatus 112, in the present embodiment the pair of wheels 224 are axially aligned and operatively coupled to the axle 226. The axle 226 may be received by and within the indentation 220, and the axel 226 may be secured within the indentation 220 via an interference fit. In embodiments, one or more fasteners may be utilized to fix the axel 226 in the indentation 220. The wheels 224 may then be operatively coupled to the axle 226 by extending the opposing ends of the axle 226 (i.e., opposite axel ends of the axle 226) into a hole defined within the center of each discrete wheel 224, wherein the hole defined in each of the wheels 224 is operable to receive one of the opposite axel ends of the axle 226. The wheels 224 are thus arranged at opposing ends of the axle 226, and the wheels 224 may be secured to the axle 226 via fastener(s) 228. In the present embodiment, the fastener 228 comprises a nut. Further, in the present embodiment, the hole of each discrete wheel 224 may bound on opposing sides by one or more washers. In such embodiments, the outermost washer that is located at the axel end opposite the tank 102, may be secured via the bolt fastener 228 like the wheel 224 itself. The rolling apparatus 112 operatively coupled to the tank 102 makes operable the tank 102 for transport. Accordingly, a user may utilize the handle 212 to tilt the tank 102 such that the wheels 224 may contact a surface and, in embodiments, the wheels 224 may contact the ground surface due to the clearance provided by the inclined portion 223 of the back sidewall 204. Once the wheels 224 engage said surface, the user may tow (pull) the entirety of the assembly 100 to a desired location.

FIGS. 3A-3D depict aspects of the hose hanger 106, according to one or more principles of the present disclosure. In addition, FIGS. 3A-3D depict the next step in the progressive construction of the assembly 100. As described herein, the hose hanger 106 is operable for dual purposes. First, the hose hanger 106 may be operable to support and retain the hose 110 when the assembly 100 is not in use, or similarly, when the entire length of the hose 110 is not required for a particular end use application. In addition and concurrently, the hose hanger 106 may also be operable as an enclosure wherein a power source 301 (see FIG. 3D) may be received and secured within the structure of the hose hanger 106.

The hose hanger 106 includes a hose hanger body 302. The hose hanger body 302 includes an enclosure portion 306 that is recessed within the tank 102 and that houses the power source 301, such that the enclosure portion 306 defines an internal compartment or housing within which the power source 301 is received. In particular, the enclosure portion 306 defines an internal cavity 325 within which the power source 301 may be provided. The exterior of the internal enclosure 306 may be sized to be received by the cavity 214 of the tank 102. In addition, the hose hanger body 102 also includes an appendage 304 that is connected to and extends from the enclosure portion 306 of the body 302. When the body 302 is installed in the cavity 214 of the tank 102, the appendage 304 will extend in an upward direction, that is directed from the rear sidewall 204 towards the front sidewall 204 as shown by arrow 303, and in an outward direction that is directed radially outward from the cavity 214 toward the top wall 208 of the tank 102 as indicated by arrow 305. More specifically, the appendage 304 is a bent member having a first portion 304a that extends from the enclosure portion 306 in the direction indicated by the arrow 303, and a second portion 304b that extends from the first portion 304a and is angled relative to the first portion 304a, wherein the second portion 304b extends in the direction indicated by the arrow 305. The first portion 304a of the appendage 304 may have a similar contour as the angled sidewall 215 of the cavity 214 and may at least partially abut the sidewall 215 when the hose hanger 106 is assembled on the tank body 102. However, the first portion 304a of the appendage 304 extends further than the sidewall 215 of the cavity 214 and extends outward of the cavity 214, such that the first portion 304a extends beyond the front sidewall 204 to thereby position the second portion 304b at a distance from the front sidewall 204 (i.e., such that the second portion 304b is offset from the front sidewall 204 at a distance). By spacing or offsetting the second portion 304b from the front sidewall 204 in this manner, a gap or space 307 is created/defined between the second portion 304b and the front sidewall 204, wherein the hose 110 may be received/stored in the gap 307.

The enclosure portion 306 of the hose hanger body 302 is operable to receive, house, and secure the power source 301 for the assembly 100, which is operable to provide power to the pump 108. In the illustrated embodiment, the power source 301 comprises a tray 309 and a plurality of discrete batteries 311 that are supported by the tray 309 and removable from the tray 309 such that they may be replaced. In an embodiment, the discrete batteries 311 comprises eight AA batteries; however, more or less may be utilized. Also in the illustrated embodiment, a handle or strap 331 is attached to the tray 309 to facilitate removal of the tray from the internal cavity 325 of the enclosure portion 306, and a tether 333 is connected to both the tray 309 and the enclosure portion 306 (i.e., the tether 333 interconnects the tray 309 and the enclosure portion 306) such that the tray 309 is firmly attached to the enclosure portion 306 to inhibit straining the wires 315 where a user removes the tray 309 from the internal cavity 325.

The hose hanger 106 further includes a means for controlling and activating/deactivating the pump 108. In the illustrated embodiment, means is a switch 313 that a user may manually manipulate to selectively activate or deactivate the pump 108. In addition, the hose hanger 106 includes a first set of wires 315 that connect the tray 309 (and the batteries 311 conductively coupled to the tray 309) to the switch 313. Further, the hose hanger 106 includes a second set of wires 317 and a connector 308, wherein the second set of wires 317 extend from the switch 313 and terminate at the connector 308, such that the connector 308 is in electrical communication with the switch 313. The connector 308 is configured to be connected to a mating connector 319 of a cable 310 that extends to the pump 108, wherein the cable 310 is a wire harness configured to electrically interconnect the hose hanger 106 and the pump 108. As shown, the connector 308 is supported by and connected to an external surface of the hanger body 302.

The cable 310 of the assembly 100 is a wire harness extending between the pump 108 and the electronics of the hose hanger 106, such that the cable 310 interconnects the pump 108 and the hose hanger 106. The connector 319 of the cable 310 is configured to mate with the connector 308. While FIG. 3D illustrates the connector 319 of the cable 310 when disconnected from the connector 308 associated with the power source 301, FIG. 3C illustrates the connector 319 when connected to the connector 308 such that the pump 108 may be in electrical connection with the power source 301 whereby the power source 301 may supply power to the pump 108 depending on the position of the switch 313. Thus, the cable 310 functions to transmit power from the hose hanger 106 (and, in particular, the power source 301 therein) to the pump 108 positioned within and protected by, the pocket 218 of the tank 102.

The exterior of the body 302 of the hose hanger 106 may include one or more ridges 312 that may protrude outwardly therefrom, for example, outwardly from the enclosure portion 306 of the body 302 as shown in FIGS. 3C and 3D. In the illustrated embodiment, the ridge(s) 312 are defined and configured to receive and secure the connector 308, such that the connector 308 is stationary relative to the body 302 of the hose hanger 106. Accordingly, in the present embodiment, the ridge(s) 312 include depressions such that the connector 308 may be emplaced within the depressions of the ridge(s) 312 by means of an interference fit. Alternatively, the connector 308 may be operatively coupled to the body 302 of the hose hanger 106 by other means without departing the scope of this disclosure.

In the present embodiment, the body 302 of the hose hanger 106 includes an outwardly facing panel 314 that comprises a generally circular body that may be operatively coupled to the enclosure portion 306. The panel 314 may further include a 12V DC barrel jack 321 operable to receive an external power source (not illustrated), such as a compatible 12V DC source. The hose hanger 106 includes additional wires (not shown) that connect the jack 321 to the second set of wires 317 and the connector 308. Thus, the assembly 100 (and the pump 108 thereof) may be powered by an external power source that is connected to the jack 321 even where the power source 301 has been removed. Additionally, the assembly 100 may include controls operable to select which power source powers the assembly. For example, the switch 313 may be toggled in a first position to activate the power source 301 or may be toggled to a second position to activate the jack 321, and the switch 313 may have a third position between the first and second position wherein the assembly 100 is turned off. In other embodiments, the switch 313 simply turns the assembly 100 on or off, and the hose hanger 106 includes a controller that is programmed and operable to automatically draw power from the power source 301 and/or the jack 321. In embodiments, and the hose hanger 106 includes a controller that is programmed to automatically draw power from the external power source when connected to the jack 321 but, when no such external power source is connected to the jack 321, the controller is programmed to automatically cause the assembly 100 to draw power from the power source 301.

Further, the body 302 of the hose hanger 106 includes a door 323 operable for closing and sealing the power source 301 within the cavity 325 of the enclosure portion 306. In the illustrated example, the door 323 is connected to the panel 314 via a hinge, such that the door 323 may pivot between a closed position, where the power source 301 is sealed within the cavity 325, and an open position, where the power source 301 is exposed to the external environment and accessible by the user, for example, to replace it. The door 323 may include a seal or gasket such that it seals the internal cavity 325 when closed, thereby making the internal cavity 325 water pater or weather proof when the door 323 is closed.

During the assembly 100 manufacture, the hose hanger 106 may be coupled to the tank 102 by inserting the internal enclosure 306 into the cavity 214 such that the panel 314 may be level with the plane of the front sidewall 204. Similarly, once the enclosure portion 306 is secured within the cavity 214, the appendage 304 may protrude outwardly from the tank 102 such that the appendage 304 may be operable to receive a portion the hose 110. Additionally, once the enclosure portion 306 is emplaced in the cavity 214, the cable 310 may extend from the base of hose hanger 106 in a downward direction. The enclosure portion 306 may have one or more openings (not shown) that align with channels 246 that extend through the tank 102, as described above. Thus, when the hose hanger 102 is set within the cavity 214, one or more fasteners may be inserted, via the channels 246, through the base surface 245 of the cavity 244 and the through base surface 217 of the cavity 214, and into the openings in the enclosure portion 306. In embodiments, the fasteners (e.g., bolts) are supported on the enclosure portion 306, and extend through the base surface 217 and out through the base surface 245 of the cavity 244, where they are fastened within the cavity 244 via nuts. In embodiments, the fasteners (e.g., bolts) are integrally connected to the enclosure portion 306. In other embodiments, the fasteners (e.g., bolts), are extended through the base surface 245 and out through the base surface 217 of the cavity 217, and the nuts are placed on the fasteners within the cavity 214. In such embodiments, the nuts may be integrally formed on the enclosure portion 206.

When the hose hanger 106 is installed on the tank 102 in this manner, the cable 310 may be routed through the channel 216, as shown in FIGS. 3A and 3B.As shown, the cable 310 extends through the channel 216, such that the wire 310 extends toward the base 210 of the tank 102, and an end 329 of the cable 310 that is opposite the connector 319 extends into the pocket 218, such that the cable 310 may be electrically connected to the pump 108 that is to be mounted in the pocket 218. Thus, the end 329 of the cable 310 is positioned below the surface of the front sidewall 204, with a connector (not shown) at the end 329 of the cable 310 extending into the pocket 218 for connection to the pump 108. Emplacing the cable 310 within the channel 216 is advantageous for the longevity of the cable 310, as the body 202 of the tank 106 protects the cable 310, and such placement of the cable 310 prevents the cable 310 from inadvertent disconnection or damage.

FIG. 4A is a partial schematic of the assembly 100 when the pump 108 is fully installed, according to one or more principles of the present disclosure. FIG. 4B is an enlarged schematic view of the pump 108 of FIG. 4A when not fully connected. As shown, the assembly 100 includes a fuel pickup assembly 400. As more fully described below, the fuel pickup assembly 400 extends into the interior volume of the body 202 of the tank 102, and the fuel pickup assembly 400 is configured to be attached to the pump 108 such that the pump 108 may draw in (pump) fluid from the interior volume of the body 202 via the fuel pickup assembly 400, and then the pump 108 may direct that fluid into the hose 110. FIG. 4C illustrates an example of the fuel pickup assembly 400, according to one or more embodiments.

The fuel pickup assembly 400 includes a bent fuel pick up 402 and a ball valve 404 operatively connected to the bent fuel pick up 402. The bent fuel pickup 402 comprises a generally cylindrical body with a hollow interior operable to receive fluid and permit fluid flow through the generally cylindrical body thereof. The cylindrical body of the bent fuel pickup 402 includes a bend, and the bend in the cylindrical body positions a distal end 410 of the cylindrical body proximate to the base 210 such that fluid pooling at the bottom of the tank 102 may be sucked up into and through the distal end 410. In embodiments, the bend in the cylindrical body is defined by a radius, such that it is a circular bend. In other embodiments, the bend is defined by an angle (i.e., such that the bend defines an obtuse angle, an acute angle, or a right angle). The bent fuel pickup 402 may be operatively coupled to the ball valve 404 via threaded engagement, weld, interference fit or some other connection means. The fuel pickup assembly 400 is configured to be positioned within the pocket 218, with the cylindrical body of the bent fuel pickup 402 being emplaced within and extending through the aperture 219 so that a distal end 410 of the bent fuel pickup 402 may extend into the interior body of the tank 202 towards and proximate to the base 210 such that fluid pooling at the bottom of the tank 102 may be sucked up into and through the distal end 410.

In the illustrated embodiment, the pickup assembly 400 includes threads 412 that engage with corresponding threads (not shown) provided in the aperture 219, such that the pickup assembly 400 may be attached to the tank 102 separate from the means by which the pump 108 is attached to the tank 102. In the illustrated embodiment, the threads 412 are provided on the valve 404. Also in embodiments, the pickup assembly 400 includes a sealing means to help facilitate creation of a seal between the pickup assembly 400 and the tank 102 when the assembly 400 is attached to the tank 102. In the illustrated embodiment, the sealing means is an O-ring 413 operable to create a seal. The ball valve 404 may include an exterior body with an outer diameter greater than the diameter of the aperture 219 prevents the entirety of the bent fuel pickup 402 from entering the interior of the tank 202. In embodiments, a fitting (not shown) is provided in the aperture 219 for attaching the fuel pickup assembly 400 to the tank 102 and, in such embodiments, the exterior threads 412 of the ball valve 404 may threadingly engage the interior threads of the fitting emplaced within the aperture 219, thereby securing the fuel pickup assembly 400 into place. The valve 404 further includes an output connection 414 that is configured to be connected to a corresponding input nozzle or connection 416 of the pump 108. Thus, the hollow interior conduit of the fuel pickup assembly 400 extends from the distal end 410 of the bent fuel pickup 402, through the valve 404 body, and to the output connection 414. Once secure, the output connection 414 of the ball valve 404 may extend in a direction where the flow there through is parallel to the base 210 of the tank 102, to thereby enable connection to the input connection 416 of the pump 108. The ball valve 404 further includes a lever 418 that is actuatable to fully open or fully close the ball valve 404. In embodiments, a sealing means is provided at the output connection 414 to facilitate creating a sealed connection between the pickup assembly 400 and the pump 108 and, in the illustrated embodiment, the sealing means is a gasket 415 provided within an interior of the output connection 414.

The pump 108 may be operatively coupled to the ball valve 404 via threaded engagement between the output connection 414 of the fuel pickup assembly 400 and the input connection 416 of the pump 108. Accordingly, the input connection 416 of the pump 108 includes an exterior threaded portion compatible to threadingly engage the interior threads of the output connection 414 of the ball valve 404. The pump 108 includes a nozzle 406 operable to receive an end 601 (see FIG. 6A) of the hose 110. The nozzle 406 may comprise a generally cylindrical body, the exterior of which is defined by a barb fitting (ridges). The nozzle 406 may extend outwardly from the exterior of the pump 108 remaining within the pocket 218. The end 601 of the hose 110 may be positioned over the nozzle 406 such that the barb fitting of the nozzle 406 is extended into the interior body of the end 601 of the hose 110. In the present embodiment, a clamp may be emplaced over the portion of the end 601 of the hose 110 that extends over and covers the nozzle 406, thereby operatively coupling and securing the hose 110 to the nozzle 406.

The pump 108 includes an electrical connection 408 configur4ed to receive the end 329 of the cable 310, such that the pump 108 may receive power from the power source 301 (and/or from the external power source). In the illustrated embodiment, the electrical connection 408 is a female connection operable to receive a male connector operatively coupled to the distal end 329 of the cable 310. Discussed above, the cable 310 may be emplaced within the channel 216 terminating into the pocket 218. As illustrated in FIG. 4A, the cable 310 may be configured to connect with/to (via the male connector at the end 329 thereof) the (female) electrical connection 408 of the pump 108. The coupling of the cable 310 to the pump 108 makes operable the pump 108 via either the power source 301 and/or the external power source connected to the jack 321.

Upon selection of receiving power from either the power source 301 and/or the jack 321 via the switch 313 emplaced upon the panel 314 (FIG. 3B), the assembly 100, more particularly, the pump 108, may be operable to draw fuel from the interior of the tank 102, through the fuel pickup assembly 402, and send that fuel through the hose 110 and to the dispensing apparatus 111, and then into the user selected vehicle.

Referring now to FIGS. 5A-5D, the fuel cap 104 is illustrated according to one or more embodiments. In the illustrated embodiment, the fuel cap 104 includes a cap body 502 and a plurality of flanges 504 extending from the body 502. Here, the flanges 504 each include a plurality of ribs (i.e., each of the flanges 504 is ribbed) configured for a user to grasp/hold, which will thereby facilitate the user's ability to install the fuel cap 104 on the on the neck 105 of the tank 102 to close the opening 107. As shown, the fuel cap 104 includes a plurality of internal threads 506 that are configured to mate with external threads provided around an external surface of the neck 105 of the tank 102. Also in the illustrated embodiment, the fuel cap 104 includes an umbrella valve 510 configured to allow the assembly 100 to automatically vent gases within the interior volume of the tank 102. Here, the umbrella valve 510 includes a flange portion 512 and an insert portion 514 extending from the flange portion 512, with the flange portion 512 disposed against (and abutting) a lower side 518 of the body 502 and the insert portion 514 extending upward from the flange portion 512 towards the lower side 518 and into and at least partially through an opening 516 in the body 502, such that a seal is formed between the opening 516 of the body and the external sides of the insert portion 516. The umbrella valve 510 includes an opening 520 extending through the insert portion 516 that is normally closed, but may be forced open to vent gas within the internal volume of the tank 102 when the gas within the internal volume of the tank 102 reaches a threshold pressure. In this manner, the umbrella valve 510 provides for automatic venting of the assembly 100.

FIG. 6A illustrates the hose assembly 109, according to one or more embodiments of the present disclosure. As previously mentioned, the hose assembly 109 includes the hose 110 and the dispensing apparatus 111, wherein the dispensing apparatus 111 is fluidly connected to a distal end 603 of the hose 110. Also, as previously mentioned, the hose 110 includes the proximal end 601, which is opposite the distal end 603, wherein the proximal end 601 is fluidly coupled to the pump 108 such that the pump 108 may discharge fluid from the pump 108 and into the hose 110. The proximal end 601 of the hose 110 includes a bend 605 that is appropriately angled to position the proximal end 601 in an orientation where it can be attached to the nozzle 406 of the pump 108. Also in the illustrated embodiment, the hose assembly 109 includes a rigid sleeve 611 arranged around a portion of the hose 110. The rigid sleeve 611 is operable to inhibit twisting or kinking of the hose 110 and to maintain a substantially straight orientation of the hose 110 proximate to the pump 108 and as the hose 110 travels away from the nozzle 406. In the illustrated embodiment, the sleeve 611 is attached to the hose 110 via a clamp 613.

The hose assembly 109 also includes a hose clip 615. In the illustrated embodiment, the hose clip 615 is positioned proximate to the distal end 603. Here, the hose clip 615 is includes a first portion 617 arranged around a portion of the hose 110 proximate to the distal end 603 and a second portion configured to snap on to a central portion of the hose 110 (i.e., the central portion of the hose 110 being in between the distal end 603 and the proximal end 601) when the hose 110 is wrapped or draped around the hose hanger 106. FIG. 6B further illustrates the hose clip 615 when removed from the hose 110. As shown, the first portion 617 is provided around a first portion of the hose 110, and the second portion 619 of the hose clip 615 is attachable to a second portion of the hose 110 to releasably secure the second portion of the hose 110 proximate to the first portion of the hose 110. Thus, the hose clip 615 is supported by the hose 110, and operable to releasably secure a part of the second portion of the hose 110 to the first portion of the hose 110.

FIG. 7 illustrates a side cross-sectional view of the dispensing apparatus 111, according to one or more embodiments of the present disclosure. In the illustrated embodiment, the dispensing apparatus 111 includes an inlet nozzle 702 and an output nozzle 704, with a fluid conduit 706 extending between the inlet nozzle 702 and the output nozzle 704. The inlet nozzle 702 is connected to the distal end 603 of the hose 110. Thus, fluid may enter the inlet nozzle 702 of the dispensing apparatus 111, the flow through the fluid conduit 706 thereof and be emitted/dispensed out through the output nozzle 704. The dispensing apparatus 111 also includes a housing 708 through which the fluid conduit 706 extends. The dispensing apparatus 111 also includes a seal mechanism 710 at least partially contained within the housing 708, wherein the seal mechanism 710 may be activated to open or close the fluid conduit 706. The seal mechanism 710 includes a diaphragm 712 that is flexible and movable upon application or removal of external or internal forces. In the illustrated embodiment, the dispensing apparatus 111 includes a handle 714 that is connected to a valve stem 716, wherein actuation of the handle 714 moves the diaphragm 712 to thereby open the fluid conduit 706. In addition, a spring 718 is provided around the valve stem 716 to bias the diaphragm into the closed position wherein the fluid conduit 706 is closed. Thus, when the handle 714 is activated with force sufficient to overcome the bias force provided by the spring 718, the valve stem 716 will be pulled downward (away from the fluid conduit 706) and pull the diaphragm 712 downward with it into the unsealed position, to thereby open the fluid conduit 706; and, upon release of the handle 714, the spring 718 will automatically move the diaphragm back into the sealed position where the fluid conduit 706 is closed. In embodiments, the diaphragm is made from a fluorocarbon-based fluoroelastmer material (i.e., a FKM material). In addition, the dispensing apparatus 111 includes numerous seals and O-rings and, in some embodiments, the seals and O-rings are operable in high-pressure environments, such as pressures as high as 15 pounds per square inch (psi).

In the illustrated embodiment, the dispensing apparatus 111 also includes a drip cap assembly 720. As hereinafter described, the drip cap assembly 720 is operable for closing the output nozzle 704 such that fluid is inhibited from leaking/flowing out of the output nozzle 704 when unintended. Here, the drip cap assembly 720 includes a cap portion 722 and a tether 724, wherein the cap portion 722 may be placed on the output nozzle 704 to seal the output nozzle 704 closed, and then removed from the output nozzle 704 to permit fluid to exit therefrom. The cap portion 722 is connected to the housing 708 via the tether 724, such that the cap portion 722 is connected to the housing 708 via the tether 724 even when removed from the output nozzle 704.

Embodiments disclosed herein include:
A. a fuel tank assembly, comprising: a tank defining an interior volume; a pump in communication with the interior volume of the tank, the pump having an output nozzle; a hose coupled to the output nozzle of the pump, such that the hose is operable to receive fluid transmitted by the pump; and a hose hanger operatively coupled to the tank and configured to retain the hose.
B. a fuel tank assembly, comprising: a tank defining an interior volume; a pump in communication with the interior volume of the tank, the pump having an output nozzle; a hose coupled to the output nozzle of the pump, such that the hose is operable to receive fluid transmitted by the pump; a hose hanger operatively coupled to the tank and configured to retain the hose; a power source operative to power the pump; a dispensing apparatus provided on a distal end of the hose, the dispensing apparatus being operable to discharge fluid received from the pump though the hose; and a rolling apparatus operatively coupled to the tank and configured to enable the transport of the assembly.
C. a fuel tank assembly, comprising: a tank defining an interior volume; a pump in communication with the interior volume of the tank, the pump having an output nozzle; a hose coupled to the output nozzle of the pump, such that the hose is operable to receive fluid transmitted by the pump; a hose hanger operatively coupled to the tank and configured to retain the hose, wherein the hose hanger further comprises: a power jack that is in electrical communication with the pump, the power jack configured to receive power from an external power source, and a tray configured to retain a plurality of batteries, the tray being removably provided within a cavity of the enclosure portion; a wire harness electrically connecting the pump to both the tray and the power jack; a dispensing apparatus provided on a distal end of the hose, the dispensing apparatus being operable to discharge fluid received from the pump though the hose; and a rolling apparatus operatively coupled to the tank and configured to enable the transport of the assembly.

Each of embodiments A through C may have one or more of the following additional elements in any combination: Element 1: further comprising a hose clip connected to a first portion of the hose, the hose clip being releasably attachable to a second portion of the hose to secure the section portion of the hose proximate to the first portion of the hose. Element 2: further comprising a fuel pick up assembly in communication with the interior volume of the tank and an input nozzle of the pump, the fuel pick up assembly further comprising a bent fuel pick up arranged within the interior volume. Element 3: the fuel pick up assembly further comprising a valve operable to open or close flow through the fuel pick up assembly.

Element 4: wherein the hose hanger includes an appendage around which the hose may be draped. Element 5: wherein the hose hanger includes an enclosure portion recessed within a cavity of the tank. Element 6: further comprising a power source housed within the enclosure portion of the hose hanger, the power supply is in electrical communication with the pump. Element 7: wherein the power supply comprises a tray configured to retain a plurality of batteries, the tray being removably provided within a cavity of the enclosure portion. Element 8: further comprising a tether operable to physically connect the tray to the enclosure portion of the hose hanger. Element 9: wherein the hose hanger includes a power jack that is in electrical communication with the pump, the power jack configured to receive power from an external power source. Element 10: further comprising a removable battery housed within a cavity the hose hanger and being in electrical communication with the pump, the fuel tank assembly further comprising a switch electrically connected to the pump, the power jack, and the removable battery, the switch being operable to switch between the removable battery and the external power source. Element 11: wherein the tank further comprises a neck with an opening that communicates with the interior volume of the tank, the fuel tank assembly further comprising a fuel cap removably provided on the neck of the tank. Element 12: wherein the fuel cap further comprises an umbrella valve. Element 13: further comprising a dispensing apparatus provided on a distal end of the hose, the dispensing apparatus being operable to discharge fluid received from the pump though the hose. Element 14: wherein dispensing apparatus includes a diaphragm constructed from an FKM material. Element 15: wherein dispensing apparatus includes an output nozzle and a drip cap arranged on the output nozzle and operable to close the output nozzle. Element 16: further comprising a rolling apparatus operatively coupled to the tank and configured to enable transport of the fuel tank assembly. Element 15: wherein the power source is either a removable battery pack housed in an enclosure portion of the hose hanger or an external power source connected a power jack provided on the hose hanger.

By way of non-limiting example, exemplary combinations applicable to A through C include: Element 3 with Element 2; Element 6 with Element 5; Element 7 with Element 6 and Element 5; Element 8 with Element 6 and Element 5; Element 10 with Element 9; Element 12 with Element 11; Element 14 with Element 13;Element 15 with Element 13; and Element 15 with Embodiment B.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A fuel tank assembly, comprising:
a tank defining an interior volume;
a pump in communication with the interior volume of the tank, the pump having an output nozzle;
a hose coupled to the output nozzle of the pump, such that the hose is operable to receive fluid transmitted by the pump; and
a hose hanger operatively coupled to the tank and configured to retain the hose.

2. The fuel tank assembly of claim 1, further comprising a hose clip connected to a first portion of the hose, the hose clip being releasably attachable to a second portion of the hose to secure the section portion of the hose proximate to the first portion of the hose.

3. The fuel tank assembly of claim 1, further comprising a fuel pick up assembly in communication with the interior volume of the tank and an input nozzle of the pump, the fuel pick up assembly further comprising a bent fuel pick up arranged within the interior volume.

4. The fuel tank assembly of claim 3, the fuel pick up assembly further comprising a valve operable to open or close flow through the fuel pick up assembly.

5. The fuel tank assembly of claim 1, wherein the hose hanger includes an appendage around which the hose may be draped.

6. The fuel tank assembly of claim 1, wherein the hose hanger includes an enclosure portion recessed within a cavity of the tank.

7. The fuel tank assembly of claim 6, further comprising a power source housed within the enclosure portion of the hose hanger, the power supply is in electrical communication with the pump.

8. The fuel tank assembly of claim 7, wherein the power supply comprises a tray configured to retain a plurality of batteries, the tray being removably provided within a cavity of the enclosure portion.

9. The fuel tank assembly of claim 7, further comprising a tether operable to physically connect the tray to the enclosure portion of the hose hanger.

10. The fuel tank assembly of claim 1, wherein the hose hanger includes a power jack that is in electrical communication with the pump, the power jack configured to receive power from an external power source.

11. The fuel tank assembly of claim 10, further comprising a removable battery housed within a cavity the hose hanger and being in electrical communication with the pump, the fuel tank assembly further comprising a switch electrically connected to the pump, the power jack, and the removable battery, the switch being operable to switch between the removable battery and the external power source.

12. The fuel tank assembly of claim 1, wherein the tank further comprises a neck with an opening that communicates with the interior volume of the tank, the fuel tank assembly further comprising a fuel cap removably provided on the neck of the tank.

13. The fuel tank assembly of claim 12, wherein the fuel cap further comprises an umbrella valve.

14. The fuel tank assembly of claim 1, further comprising a dispensing apparatus provided on a distal end of the hose, the dispensing apparatus being operable to discharge fluid received from the pump though the hose.

15. The fuel tank assembly of claim 14, wherein dispensing apparatus includes a diaphragm constructed from an FKM material.

16. The fuel tank assembly of claim 14, wherein dispensing apparatus includes an output nozzle and a drip cap arranged on the output nozzle and operable to close the output nozzle.

17. The fuel tank assembly of claim 1, further comprising a rolling apparatus operatively coupled to the tank and configured to enable transport of the fuel tank assembly.

18. A fuel tank assembly, comprising:
a tank defining an interior volume;
a pump in communication with the interior volume of the tank, the pump having an output nozzle;
a hose coupled to the output nozzle of the pump, such that the hose is operable to receive fluid transmitted by the pump;
a hose hanger operatively coupled to the tank and configured to retain the hose;
a power source operative to power the pump;
a dispensing apparatus provided on a distal end of the hose, the dispensing apparatus being operable to discharge fluid received from the pump though the hose; and
a rolling apparatus operatively coupled to the tank and configured to enable the transport of the assembly.

19. The fuel tank assembly of claim 18, wherein the power source is either a removable battery pack housed in an enclosure portion of the hose hanger or an external power source connected a power jack provided on the hose hanger.

20. A fuel tank assembly, comprising:
a tank defining an interior volume;
a pump in communication with the interior volume of the tank, the pump having an output nozzle;
a hose coupled to the output nozzle of the pump, such that the hose is operable to receive fluid transmitted by the pump;
a hose hanger operatively coupled to the tank and configured to retain the hose, wherein the hose hanger further comprises:
a power jack that is in electrical communication with the pump, the power jack configured to receive power from an external power source, and
a tray configured to retain a plurality of batteries, the tray being removably provided within a cavity of the enclosure portion;
a wire harness electrically connecting the pump to both the tray and the power jack;
a dispensing apparatus provided on a distal end of the hose, the dispensing apparatus being operable to discharge fluid received from the pump though the hose; and
a rolling apparatus operatively coupled to the tank and configured to enable the transport of the assembly.
